(19) United States
(12) Patent Application Publication
(10) Pub. No.: US 2024/0109804 A1
(43) Pub. Date: Apr. 4, 2024

(54) HIGH-INDEX GLASS

(71) Applicant: Schott AG, Mainz (DE)

(72) Inventors: Bianca Schreder, Mainz (DE); Ute Wölfel, Mainz (DE); Stefanie Hansen, Mainz (DE)

(73) Assignee: Schott AG, Mainz (DE)

(21) Appl. No.: 18/478,144

(22) Filed: Sep. 29, 2023

(30) Foreign Application Priority Data
Sep. 29, 2022 (DE) 10 2022 125 160.8

(51) Int. Cl. C03C 3/068

(52) U.S. Cl. CPC C03C 3/068

(57) ABSTRACT

A glass having a refractive index at a wavelength of about 587.6 nm of 1.95 to 2.05 and a dispersion of 22 to less than 35 includes the following components in % by weight: 4-12 SiO₂; 4-11 B₂O₃; <10 BaO; 30-<52 La₂O₃; <14 Gd₂O₃; <5.5 ZrO₂; 10-25 TiO₂; 3-16 Nb₂O₅; and ≤2.0 ZnO. A sum total of the proportions by weight of SiO₂ and B₂O₃ is at least 10% by weight.

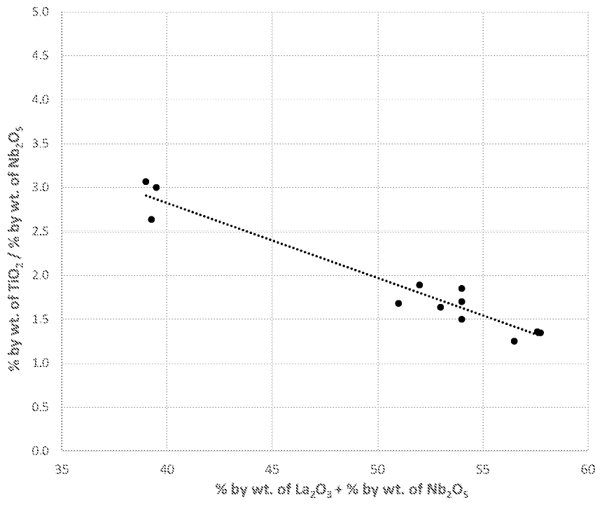

### CROSS REFERENCE TO RELATED APPLICATIONS

This application claims priority to German Patent Application No. 10 2022 125 160.8 filed on Sep. 29, 2022, which is incorporated in its entirety herein by reference.

### BACKGROUND OF THE INVENTION

### 1. Field of the Invention

The present invention relates to glasses having high refractive index, especially a refractive index n_{d} of 1.95 to 2.05 and an Abbe number yd. of 22 to less than 35. The glasses may have high transmittance in the visible wavelength range, especially also in the lower visible wavelength range. The invention also relates to the use of the glasses. The glasses provided according to the invention may especially be used for AR eyeglasses. Further uses are, for example, applications as a lens or optical waveguide in the optics sector.

### 2. Description of the Related Art

The field of augmented reality (AR) has gained increasing significance. This is understood to mean augmentation of reality, especially to include computer-generated information presented visually. For this purpose, special eyeglasses are frequently used, called AR eyeglasses. For the production of such eyeglasses, glasses of particularly high refractive index are required, which extend the field of view (FoV). Moreover, the glasses should preferably have particularly good transmittance in the visible wavelength range. A particular problem in this connection with particularly high-index glasses has been found to be transmittance in the lower visible wavelength range, for example in the blue range from 420 nm to 490 nm, in particular at 420 nm or 460 nm. In this connection, reference is also made to the “UV edge” of the glass. If the UV edge has been shifted too far into the visible region or does not rise steeply enough, transmittance properties in the lower visible wavelength range are not good. Moreover, it has been found to be difficult to provide glasses that have a particularly high refractive index throughout the visible range (especially from 380 nm to 750 nm). For example, there are known glasses that have a refractive index nd of 2.001, but which do not attain a refractive index of at least 2.000 at other wavelengths in the visible range.

Glasses made from the niobium phosphate system in particular have been used in the past. However, these glasses are very problematic in terms of production since loss of oxygen, especially as a result of high melting and refining temperatures in the already reducing phosphate system, leads to lower oxidation states of Nb than V and hence to an intense brown to black color. Moreover, this glass family not only has a tendency to interfacial crystallisation, like the lanthanum borates or borosilicate systems as well, but also shows very rapid crystal growth, which makes post-cooling (stress cooling or refractive index adjustment) critical for possibly pre-nucleated glasses. Moreover, the glass is relatively brittle and therefore difficult to polish to thin wafers.

In particular, therefore, glasses are to be provided that have a refractive index throughout the visible spectrum of 1.93 to 2.08 and/or a refractive index nd of 1.95 to 2.05. The glasses are preferably notable for excellent transmittance properties, especially also in the lower visible wavelength range, for example at 420 nm and/or 460 nm. Moreover, batch costs should remain modest. The glass should have high potential for streak-free manufacture. Furthermore, it should be possible to shape the glass to wafers with good yield. The glass should in particular have good hot formability and good processibility. In spite of the high refractive index, the glasses should have minimum density. This can especially increase the wear comfort of AR eyeglasses.

What is needed in the art is a way to provide glasses that overcome the disadvantages from the prior art.

### SUMMARY OF THE INVENTION

In some embodiments provided according to the invention, a glass has a refractive index at a wavelength of about 587.6 nm of 1.95 to 2.05 and a dispersion of 22 to less than 35 and includes the following components in % by weight: 4-12 SiO₂; 4-11 B₂O₃; <10 BaO; 30-<52 La₂O₃; <14 Gd₂O₃; <5.5 ZrO₂; 10-25 TiO₂; 3-16 Nb₂O₅; and ≤2.0 ZnO. A sum total of the proportions by weight of SiO₂ and B₂O₃ is at least 10% by weight.

In some embodiments provided according to the invention, a glass article includes a glass having a refractive index at a wavelength of about 587.6 nm of 1.95 to 2.05 and a dispersion of 22 to less than 35 and includes the following components in % by weight: 4-12 SiO₂; 4-11 B₂O₃; <10 BaO; 30-<52 La₂O₃; <14 Gd₂O₃; <5.5 ZrO₂; 10-25 TiO₂; 3-16 Nb₂O₅; and ≤2.0 ZnO. A sum total of the proportions by weight of SiO₂ and B₂O₃ is at least 10% by weight. The glass article is in the form of: a spectacle lens; a stack of wafers; a wafer; a lens; a spherical lens; a prism; an asphere; an optical waveguide; a fiber; or a sheet.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

the sole FIGURE illustrates a graph of a ratio of proportions by weight of TiO₂ and Nb₂O₅ plotted against the sum total of proportions by weight of La₂O₃ and Nb₂O₅ of the glasses provided according to the invention.

The exemplification set out herein illustrates one embodiment of the invention and such exemplification is not to be construed as limiting the scope of the invention in any manner.

### DETAILED DESCRIPTION OF THE INVENTION

In some embodiments, the invention relates to a glass having a refractive index n_{d} of 1.95 to 2.05 and a dispersion v_{d} of 22 to less than 35, comprising the following components in % by weight:

| | |
|---|---|
| SiO₂ | 4-12 |
| B₂O₃ | 4-11 |
| BaO | <10 |
| La₂O₃ | 30-<52 |
| Gd₂O₃ | <14 |
| ZrO₂ | <5.5 |
| TiO₂ | 10-25 |
| Nb₂O₅ | 3-16 |
| ZnO | ≤2.0 |

where the sum total of the proportions by weight of SiO₂ and B₂O₃ is at least 10% by weight.

In some embodiments, the invention relates to a glass having a refractive index n_{d} of 1.95 to 2.05 and optionally a dispersion v_{d} of 22 to less than 35, comprising the following components in % by weight:

| | |
|---|---|
| SiO₂ | 4-12 |
| B₂O₃ | 4-11 |
| BaO | <10 |
| La₂O₃ | 30-<52 |
| Gd₂O₃ | <14 |
| ZrO₂ | <5.5 |
| TiO₂ | 10-25 |
| Nb₂O₅ | 3-16 |
| ZnO | ≤2.0 |

where the sum total of the proportions by weight of SiO₂ and B₂O₃ is at least 10% by weight.

In some embodiments, the invention relates to a glass having, throughout the visible range of the spectrum, a refractive index of 1.93 to 2.08 and a dispersion v_{d} of 22 to less than 35, comprising the following components in % by weight:

| | |
|---|---|
| SiO₂ | 4-12 |
| B₂O₃ | 4-11 |
| BaO | <10 |
| La₂O₃ | 30-<52 |
| Gd₂O₃ | <14 |
| ZrO₂ | <5.5 |
| TiO₂ | 10-25 |
| Nb₂O₅ | 3-16 |
| ZnO | ≤2.0 |

where the sum total of the proportions by weight of SiO₂ and B₂O₃ is at least 10% by weight.

According to the invention, the glass has a refractive index n_{d} of 1.95 to 2.05, optionally of 1.97 to 2.02, optionally of 1.98 to 2.01 and even optionally of 1.99 to 2.01.

The refractive index n_{d} is known to the person skilled in the art and relates more particularly to the refractive index at a wavelength of about 587.6 nm (wavelength of d line of helium). The person skilled in the art knows how the refractive index n_{d} can be determined.

The refractive index is optionally determined with a refractometer, especially with a V block refractometer. It is possible here in particular to use samples of square or virtually square footprint (for example with dimensions of about 20 mm×20 mm×5 mm). In the case of measurement with a V block refractometer, the samples are generally positioned in a V-shaped block prism of known refractive index. The refraction of incident light beam depends on the difference between the refractive index of the sample on the refractive index of the V block prism, and so the refractive index of the sample can be determined. The measurement is optionally effected at a temperature of 22° C.

The refractive index is dependent on the wavelength of the light and can be determined at various wavelengths, for example n_{d} at about 587.6 nm, nF at about 486 nm and nC at about 656 nm. The glass optionally has a refractive index of 1.93 to 2.08 throughout the visible range of the spectrum (especially from 380 nm to 750 nm).

The refractive index nF denotes the refractive index at a wavelength of about 486 nm. The refractive index nF of the glasses provided according to the present invention is optionally within a range from 1.96 to 2.08, for example from 1.98 to 2.06, from 1.99 to 2.05, from 2.00 to 2.04.

The refractive index nC denotes the refractive index at a wavelength of about 656 nm. The refractive index nC of the glasses provided according to the present invention is optionally within a range from 1.93 to 2.04, for example from 1.95 to 2.03, or from 1.96 to 2.02.

The glass has a dispersion v_{d} of 22 to less than 35, optionally of 24 to 30, optionally of 25 to 28.

According to the invention, the glass has a internal transmittance TI of at least 80%, optionally at least 85%, optionally at least 90%, optionally at least 91%, optionally at least 92%, optionally at least 93%, optionally at least 94%, optionally at least 95%, optionally at least 96%, optionally at least 97%, where internal transmittance is measured at a wavelength of 460 nm and a sample thickness of 10 mm.

Internal transmittance can be measured by methods familiar to the person skilled in the art, for example according to DIN 5036-1:1978. In this description, the internal transmittance figures are based on a sample thickness of 10 mm. The reporting of a “sample thickness” does not mean that the glass has that thickness, but merely states the thickness to which the internal transmittance FIGURE relates.

Unless stated otherwise or obvious to the person skilled in the art, measurements described herein are conducted at 20° C. and air pressure 101.3 kPa.

The density of the glasses provided according to the invention is optionally within a range from 4.40 g/cm³ to 5.30 g/cm³, optionally from 4.45 g/cm³ to 5.20 g/cm³, optionally from 4.50 g/cm³ to 5.10 g/cm³. In some embodiments, the density of the glasses is less than 5.05 g/cm³, optionally less than 5.00 g/cm³, optionally less than 4.95 g/cm³, optionally less than 4.90 g/cm³, optionally less than 4.85 g/cm³, optionally less than 4.80 g/cm³, optionally less than 4.70 g/cm³, optionally less than 4.60 g/cm³.

It is known that the density of glasses rises with rising refractive index. However, it is optionally a feature of the glasses according to the invention that density is relatively low in spite of the high refractive index. The ratio of density to refractive index n_{d} is optionally within a range from 2.10 to 2.60 g/cm³, optionally from 2.25 to 2.55 g/cm³, optionally from 2.30 to 2.50 g/cm³. The ratio of density and refractive index n_{d} is ascertained by dividing the density value (in g/cm³) by the value of refractive index n_{d}. Optionally, the ratio of density to refractive index n_{d} is less than 2.60 g/cm³, optionally less than 2.55 g/cm³, optionally less than 2.50 g/cm³, optionally less than 2.45 g/cm³, optionally less than 2.40 g/cm³, optionally less than 2.35 g/cm³.

The glass provided according to the present invention optionally has high transmittance in the visible range, especially also in the lower visible range, for example at 420 nm and/or 460 nm. The UV edge is thus optionally at comparatively short wavelengths in spite of the high-index properties.

Optionally, the internal transmittance TI of the glass, measured at a wavelength of 420 nm and a sample thickness of 10 mm, is at least 25%, optionally at least 30%, optionally at least 40%, optionally at least 50%, optionally at least 60%, optionally at least 70%, optionally at least 75%, optionally at least 80%, optionally at least 85%, optionally at least 87.5%, optionally at least 90%. In some embodiments, the internal transmittance TI of the glass, measured at a wavelength of 420 nm and a sample thickness of 10 mm, is not more than 99%, not more than 98%, not more than 95%, or not more than 92.5%.

Optionally, the internal transmittance TI of the glass, measured at a wavelength of 460 nm and a sample thickness of 10 mm, is at least 63%, optionally at least 65%, optionally at least 70%, optionally at least 75%, optionally at least 80%, optionally at least 85%, optionally at least 87.5%, optionally at least 90%, optionally at least 91%, optionally at least 92%, optionally at least 93%, optionally at least 94%, optionally at least 95%, optionally at least 96%, optionally at least 97%. In some embodiments, the internal transmittance TI of the glass, measured at a wavelength of 460 nm and a sample thickness of 10 mm, is not more than 99.99%, not more than 99.9%, not more than 99%, or not more than 98%.

If the glass transition temperature Tg is very high, the post-cooling takes longer. However, Tg is also a measure of chemical stability and hardness (the higher the Tg, the more stable the network and hence the harder and more chemically resistant the glass). While high chemical resistance is good, too high a hardness is also costly again since grinding and polishing take longer and have to be effected with greater care in order that not too many microcracks are created. The glass transition temperature Tg of the glass according to the invention is therefore optionally within a range from 650° C. to 800° C., optionally from 680° C. to 760° C., optionally from 690° C. to 750° C.

The temperature T1 at which the viscosity is 10\hat{ }1 dPas is optionally within a range from 1100° C. to 1250° C., optionally within a range from 1150° C. to 1200° C. or within a range from 1100° C. to 1150° C. or within a range from 1200° C. to 1250° C. The glass composition provided according to the present invention thus enables particularly low melting temperatures.

The temperature T4 at which the viscosity is 10\hat{ }4 dPas is optionally within a range from 875° C. to 1025° C., optionally within a range from 925° C. to 975° C. or within a range from 875° C. to 925° C. or within a range from 975° C. to 1025° C.

The softening temperature T7.6 at which the viscosity is 10\hat{ }7.6 dPas is optionally within a range from 750° C. to 900° C., optionally from 800° C. to 850° C. or from 750° C. to 800° C. or from 850° C. to 900° C.

The crystallisation temperature TK is optionally within a range from 1000° C. to 1200° C., optionally from 1025° C. to 1175° C., optionally from 1050° C. to 1150° C. or from 1025° C. to 1125° C. or from 1075° C. to 1175° C. The viscosity at TK is optionally within a range from 10 to 100 dPas.

The viscosity of a glass can be determined with a rotary viscometer, for example according to DIN ISO 7884-2:1998-2. The dependence of viscosity on temperature can be ascertained using the VFT curve (Vogel-Fulcher-Tammann equation). The softening temperature can be ascertained with the thread-pulling viscometer according to ISO 7884-2.

The glasses provided according to the invention optionally have a coefficient of thermal expansion (CTE) in the temperature range from 20° C. to 300° C. (CTE(20,300)) which is within a range from 6.7 to 10.0 ppm/K, optionally from 7.0 to 9.7 ppm/K, optionally from 7.3 to 9.4 ppm/K, optionally from 7.6 to 9.1 ppm/K, optionally from 7.8 to 8.8 ppm/K, optionally from 7.9 to 8.6 ppm/K, optionally from 8.0 to 8.5 ppm/K. The CTE should have a good match with coatings, where very high CTE values in particular often cause problems since the polymer in this range frequently, rather than having a linear CTE profile, runs even steeper. If the glass then still has a non-matching CTE, the result can be cracks or layer detachment. For these reasons among others, preference may be given to the abovementioned CTE values.

The glass optionally comprises the following components in % by weight:

| | |
|---|---|
| SiO₂ | 6.5-10.5 |
| B₂O₃ | 4.5-10 |
| BaO | 1-6.5 |
| La₂O₃ | 37-50 |
| Gd₂O₃ | 3-12 |
| ZrO₂ | ≤4.5 |
| TiO₂ | 12-20 |
| Nb₂O₅ | 5-13 |
| ZnO | ≤1.5 |

where the sum total of the proportions by weight of SiO₂ and B₂O₃ is in the range from 12 to 21 and where, optionally, the proportion of SiO₂ is greater than or equal to, optionally greater than, the proportion of B₂O₃.

Optionally, the glass comprises the following components in % by weight:

| | |
|---|---|
| SiO₂ | 7-10 |
| B₂O₃ | 5-9 |
| BaO | 2-6 |
| La₂O₃ | 39.5-49 |
| Gd₂O₃ | 4-10 |
| ZrO₂ | ≤4 |
| TiO₂ | 13-19.5 |
| Nb₂O₅ | 6.5-12 |
| ZnO | ≤1 |

where the sum total of the proportions by weight of SiO₂ and B₂O₃ is in the range from 13 to 20 and where, optionally, the proportion of SiO₂ is greater than or equal to, optionally greater than, the proportion of B₂O₃.

The glass provided according to the present invention contains SiO₂ in a proportion of 4% to 12% by weight, optionally 5% to 11% by weight. SiO₂ is a glass former. The oxide makes a major contribution to chemical resistance, but also increases processing temperatures. If it is used in very large amounts, it is not possible to achieve the refractive indices according to the invention. Optionally, the proportion of SiO₂ is within a range from 6.5 to 10.5% by weight, optionally from 7 to 10% by weight, optionally from 7.5 to 9.5% by weight.

B₂O₃ has been found to be particularly suitable for achieving low melting temperatures. Especially because of its aggressiveness against melting materials, however, the content of B₂O₃ is limited. The glass provided according to the present invention contains B₂O₃ in a proportion of 4% to 11% by weight, optionally of 4.5% to 10% by weight, optionally of 5% to 9% by weight, optionally 5.5% to 8.5% by weight.

When the sum total of the proportions by weight of SiO₂ and B₂O₃ is very high, this has an adverse effect on refractive index. On the other hand, SiO₂ and B₂O₃ are required as network formers, and so the proportion should not be very low either. The sum total of the proportions by weight of SiO₂ and B₂O₃ is therefore at least 10% by weight. The sum total of the proportions by weight of SiO₂ and B₂O₃ is optionally 11% to 22% by weight, optionally 12% to 21% by weight, optionally 13% to 20% by weight, optionally 13.5% to 19% by weight.

In some embodiments, the proportion by weight of SiO₂ is higher than the proportion by weight of B₂O₃ since SiO₂ does not give rise to any attack on the refractory material, as is the case for B₂O₃ for instance. However, B₂O₃ is more advantageous for melting characteristics. The weight ratio of the proportion of SiO₂ to the proportion of B₂O₃ (SiO₂/B₂O₃) is optionally within a range from 0.85 to 2.0, optionally from 0.95 to 1.9, optionally from 1.0 to 1.8, optionally from 1.05 to 1.75. In some embodiments, the proportion by weight of SiO₂ is greater than or equal to, optionally greater than, the proportion by weight of B₂O₃.

The weight ratio of the proportion of SiO₂ to the proportion of B₂O₃ can advantageously be used in order to suitably adjust the melting temperature and aggressiveness of the melt.

Optionally, the sum total of the proportions of La₂O₃, Nb₂O₅, TiO₂ and ZrO₂ in the glass provided according to the invention is not more than 80% by weight, optionally not more than 78% by weight, optionally not more than 76% by weight, optionally not more than 75% by weight. Optionally, the sum total of the proportions of La₂O₃, Nb₂O₅, TiO₂ and ZrO₂ is within a range from 62% by weight to 80% by weight. In some embodiments, the sum total of the proportions of La₂O₃, Nb₂O₅, TiO₂ and ZrO₂ is within a range from 68% by weight to 80% by weight, optionally in the range from 70% to 78% by weight, optionally from 71% to 76% by weight. In some embodiments, the sum total of the proportions of La₂O₃, Nb₂O₅, TiO₂ and ZrO₂ is within a range from 62 to 66% by weight, optionally from 63 to 65% by weight. A high proportion of these components may be advantageous in order to achieve a particularly high refractive index. However, there can also be an increase in propensity to crystallisation, and so it can be advantageous to limit the content.

The weight ratio of the sum total of the proportions of La₂O₃, Nb₂O₅, TiO₂ and ZrO₂ to the sum total of the proportions of SiO₂ and B₂O₃ is optionally within a range from 3.4 to 5.6, optionally from 3.8 to 5.5, optionally from 4.0 to 5.1.

The weight ratio of the sum total of the proportions of BaO, La₂O₃, Nb₂O₅, TiO₂ and ZrO₂ to the sum total of the proportions of SiO₂ and B₂O₃ is optionally within a range from 3.9 to 5.8, optionally from 4.0 to 5.7, optionally from 4.3 to 5.8.

La₂O₃, with a proportion of 30% to less than 52% by weight, is one of the main components of the glass provided according to the invention. La₂O₃ together with SiO₂ and B₂O₃ forms the dense glass network into which TiO₂ is incorporated. La₂O₃ is stable and non-redox-sensitive and is also more favorable than Gd₂O₃ and Nb₂O₅ with regard to price and availability. In some embodiments, the proportion of La₂O₃ is within a range from 35% to 51% by weight, optionally from 37% to 50% by weight, optionally from 39.5% to 49% by weight, optionally from 40% to 48% by weight, optionally from 42% to 47% by weight. If the La₂O₃ content is increased at the expense of other high-index components, this has an adverse effect on refractive index. Moreover, in the case of very high proportions of La₂O₃, there is also an increase in propensity to crystallisation. In some embodiments, the proportion of La₂O₃ is within a range from 30% to 35% by weight, optionally from 30.5% to 33% by weight.

With regard to the fact that La₂O₃ has higher redox stability or crystallisation stability than Nb₂O₅, TiO₂ and ZrO₂, it is favorable in some embodiments of the glass provided according to the invention to establish a certain minimum ratio of the proportion of La₂O₃ to the sum total of the proportions of La₂O₃, TiO₂, Nb₂O₅ and ZrO₂. On the other hand, the proportion of La₂O₃ should not be too high either with regard to the refractive index. An advantageous weight ratio of the proportion of La₂O₃ to the sum total of the proportions of La₂O₃, TiO₂, Nb₂O₅ and ZrO₂ has been found here to be in the range from 0.42 to 0.65, optionally from 0.45 to 0.64, optionally from 0.47 to 0.63, optionally from 0.59 to 0.64.

The glasses provided according to the invention contain Nb₂O₅ in a proportion of 3% to 16% by weight, optionally of 5% to 13% by weight, optionally of 6.5% to 12.5% by weight. Apart from its high influence on refractive index, Nb₂O₅ also has a positive influence on glass density. This component can lower densities. However, there can be a tendency to loss of oxygen and formation of lower oxidation states, hence resulting in more intense color. The sum total of the proportions of La₂O₃ and Nb₂O₅ is optionally within a range from 35% to 65% by weight, optionally of 45% to 62% by weight, optionally from 48% to 60% by weight. In some embodiments, the sum total of the proportions of La₂O₃ and Nb₂O₅ is optionally within a range from 35% to 45% by weight, optionally from 37% to 42% by weight. Optionally, the sum total of the proportions of La₂O₃ and Nb₂O₅ is at least 50% by weight, optionally at least 57.5% by weight.

The glasses provided according to the invention contain TiO₂ in a proportion of 10% to 25% by weight, optionally 12% to 24% by weight. In some embodiments, the proportion of TiO₂ is 12% to 20% by weight, optionally 13% to 19.5% by weight, optionally 14% to 19% by weight. In some embodiments, the proportion of TiO₂ is optionally 19% to 25% by weight, optionally 21.5% to 24% by weight. TiO₂ makes a major contribution to a high refractive index and is also helpful in keeping the density comparatively low. However, a limit in the proportion of TiO₂ can be advantageous since it can contribute to crystal growth as a nucleating agent, which complicates hot further processing, for example pressing.

ZrO₂, by contrast with TiO₂, does not have a tendency to form colored oxidation states. However, both the solubility thereof and the speed with which ZrO₂ goes into solution are limited. Relatively high proportions of ZrO₂ are unfavorable since higher temperatures are required for complete dissolution, which in turn has an adverse effect on transmittance. Moreover, the purity of ZrO₂ is not very high (impurities containing Fe in particular). There is therefore an upper limit to the content of ZrO₂. The proportion of ZrO₂ in the glasses provided according to the invention is less than 5.5% by weight, optionally less than 5% by weight, optionally less than 4.5% by weight, optionally less than or equal to 3.5% by weight. Optionally, the proportion of ZrO₂ is from 0.5% to 5% by weight, optionally from 0.5% to 4.5% by weight, optionally from 1.0% to 4.0% by weight, optionally from 1.5 to 3.5. A limit in the proportion of ZrO₂ may also be advantageous in order to inhibit potential crystal growth. Some embodiments are free of ZrO₂.

TiO₂ and ZrO₂ make a major contribution to a high refractive index, and TiO₂ in particular also contributes to a comparatively low density. On the other hand, the proportions of TiO₂ and ZrO₂ should not be too high either, especially with regard to solubility, nucleation and crystallisation. The sum total of the proportions of TiO₂ and ZrO₂ is optionally within a range from 14% to 30% by weight, optionally from 15% to 27.5% by weight, optionally from 17.5% to 22% by weight. In some embodiments, the sum total of the proportions of TiO₂ and ZrO₂ is even at least 24% by weight.

A ratio of the sum total of the proportions of TiO₂ and ZrO₂ to the sum total of the proportions of TiO₂, ZrO₂, Nb₂O₅, La₂O₃, Gd₂O₃ and Y₂O₃ in the range from 0.20 to 0.36, optionally 0.21 to 0.27, has been found to be advantageous.

The possible proportion of TiO₂ in the glass is limited because of the tendency to crystallisation. TiO₂ additionally also absorbs in the blue wavelength range, even as Ti(IV), while Nb(V) absorbs in the UV. However, reduced Nb₂O₅ causes much more absorption in the visible region than reduced TiO₂. La₂O₃, by contrast, is stable and non-redox-sensitive. Accordingly, it may be advantageous firstly to limit the TiO₂ content at the upper end in order not to move the UV absorption of the glass in the case of completely oxidized components too much into the visible region, but on the other hand to use the high nd contribution and low density contribution of TiO₂. La₂O₃ and Nb₂O₅ likewise contribute to a high refractive index, stabilise the network and—provided that they remain oxidized—keep UV transmittance within the higher range. According to all the above, it has been found to be advantageous to control the weight ratio of the sum total of the contents of ZrO₂, La₂O₃ and Nb₂O₅ to the proportion of TiO₂ and/or the weight ratio of the sum total of the contents of ZrO₂, La₂O₃, Gd₂O₃ and Y₂O₃ to the sum total of the contents of TiO₂ and Nb₂O₅, especially at the lower end.

The weight ratio of the sum total of the proportions of La₂O₃, Nb₂O₅ and ZrO₂ to the proportion of TiO₂ ((La₂O₃+Nb₂O₃+ZrO₂)/TiO₂) in the glasses provided according to the invention is optionally within a range from 1.5 to 5. In some embodiments, the weight ratio of the sum total of the proportions of La₂O₃, Nb₂O₅ and ZrO₂ to the proportion of TiO₂ ((La₂O₃+Nb₂O₃+ZrO₂)/TiO₂) is optionally within a range from 2 to 4.6, optionally from 2.5 to 4.4, optionally from 2.8 to 4.2. In some embodiments, the weight ratio of the sum total of proportions of La₂O₃, Nb₂O₅ and ZrO₂ to the proportion of TiO₂ ((La₂O₃+Nb₂O₃+ZrO₂)/TiO₂) is optionally within a range from 1.5 to 2.0, optionally from 1.7 to 1.9.

The weight ratio of the sum total of the proportions of ZrO₂, La₂O₃, Gd₂O₃ and Y₂O₃ to sum total of the proportions of TiO₂ and Nb₂O₅ in the glasses provided according to the invention is optionally within a range from 1.3 to 2.5. In some embodiments, the weight ratio of the sum total of the proportions of ZrO₂, La₂O₃, Gd₂O₃ and Y₂O₃ to the sum total of the proportions of TiO₂ and Nb₂O₅ is optionally within a range from 1.5 to 2.5, optionally from 1.6 to 2.4. In some embodiments, the weight ratio of the sum total of the proportions of ZrO₂, La₂O₃, Gd₂O₃ and Y₂O₃ to the sum total of the proportions of TiO₂ and Nb₂O₅ is optionally within a range from 1.3 to 1.5.

In view of the above-described considerations relating to color, n_{d} contribution, density contribution and crystallisation, it may also be advantageous to control the ratio of the proportions of TiO₂ and Nb₂O₅. This allows the composition, in particular, to be chosen in a stable manner such that the refractive index range is variably adjustable solely via increasing/lowering of SiO₂.

Optionally, the ratio of the weight ratio of TiO₂ to Nb₂O₅ to the sum total of the proportions of Nb₂O₅ and La₂O₃ is in the range from 0.02 to 0.08, optionally from 0.03 to 0.07, optionally from 0.035 to 0.065.

Optionally, the weight ratio of the sum total of the proportions of La₂O₃ and Nb₂O₅ to the sum total of the proportions of TiO₂ and ZrO₂ is within a range from 1.3 to 3.5, optionally from 2.0 to 3.3, optionally from 2.3 to 2.1.

The sum total of the proportions of Nb₂O₅ and ZrO₂ is optionally within a range from 7% to 17% by weight, optionally from 8% to 15% by weight, optionally from 9% to 16% by weight. In particular, it may be advantageous to limit the sum total of the proportions of Nb₂O₅ and ZrO₂ at the upper end, since relatively high proportions of ZrO₂, being a component which is particularly difficult to dissolve, can be particularly problematic in association with high Nb₂O₅ contents. This is because Nb₂O₅ crystallizes on interfaces in particular, for example ZrO₂ grains. As a result, on recompression, lowering or post-cooling, very large crystals can grow in an uncontrolled manner even in the volume and even tear the casting. There is also the risk that a thick crystalline layer will form on lowering and in the worst case even on cooling, which is extremely difficult to handle without fracture.

The glass compositions provided according to the present invention are thus based on a balance between a wide variety of different, in some cases opposing, effects. If the proportion of non-coloring components is increased too much, this can have an adverse effect on glass stability. The proportions of TiO₂ and Nb₂O₅ are optionally also very high, although it is also necessary to take note here of crystallisation processes. TiO₂ is inexpensive and has a positive effect on the refractive index, but is disadvantageous with regard to UV absorption. The result is therefore the further sums and ratios that are described hereinafter, which can lead to particularly advantageous glasses.

Optionally, the sum total of the proportions by weight of Nb₂O₅ and ZrO₂ is less than the proportion by weight of TiO₂. Optionally, the weight ratio of the sum total of the proportions of Nb₂O₅ and ZrO₂ to the proportion of TiO₂—(Nb₂O₅+ZrO₂)/TiO₂ is <1, optionally less than 0.9, optionally less than 0.8, optionally less than 0.7, and is optionally within a range from 0.5 to 0.98, optionally from 0.6 to 0.95. In some embodiments, the weight ratio of the sum total of the proportions of Nb₂O₅ and ZrO₂ to the proportion of TiO₂—(Nb₂O₅+ZrO₂)/TiO₂ is within a range from 0.35 to 0.5.

The sum total of the proportions of La₂O₃, TiO₂ and BaO is optionally within a range from 55% to 70% by weight, optionally from 60% to 68% by weight, optionally from 61% to 66% by weight. If the sum total of the proportions of La₂O₃, TiO₂ and BaO is chosen accordingly, the result is glasses having good meltability coupled with comparatively low melting temperatures and a refractive index within the target range according to the invention.

In some embodiments, it may be advantageous to control the sum total of the proportions by weight of La₂O₃, Nb₂O₅ and ZrO₂ in order firstly to ensure good meltability, especially of ZrO₂, at comparatively low melting temperatures, and secondly to ensure sufficient redox stability of Nb₂O₅.

Accordingly, the sum total of the proportions of La₂O₃, Nb₂O₅ and ZrO₂ in some embodiments is optionally within a range from 55% to 75% by weight, optionally from 57.5% to 72.5% by weight, optionally from 60% to 70% by weight. In some embodiments, the sum total of the proportions of La₂O₃, Nb₂O₅ and ZrO₂ is even at least 62.0% by weight or at least 64.0% by weight.

Optionally, the weight ratio of the proportion of TiO₂ to the proportion of ZrO₂ (TiO₂/ZrO₂) is at least 4, optionally at least 4.5, at least 5, at least 5.2. In some embodiments, the ratio is even optionally at least 6, optionally at least 7, optionally at least 8 or at least 9. A corresponding weight ratio has been found to be favorable in order to avoid melting problems with ZrO₂.

Optionally, the weight ratio of the proportion of BaO to the proportion of TiO₂ (BaO/TiO₂) is within a range from 0.13 to 0.35, optionally from 0.16 to 0.33. It may be advantageous here to limit the ratio at the upper end, since there can otherwise be unwanted lowering of the refractive index. On the other hand, the ratio should not go below the lower limit mentioned since it is otherwise no longer possible to assure sufficient stabilization of TiO₂ in the glass system.

The glasses provided according to the invention contain Gd₂O₃ in a proportion of less than 14% by weight, optionally 3% to 12% by weight, optionally 4% to 10% by weight, optionally from 4.5% to 9% by weight. Very high proportions of Gd₂O₃ can adversely affect glass stability.

The glasses provided according to the invention may contain Y₂O₃. Optionally, the proportion of Y₂O₃ is within a range from 0% to 5% by weight, optionally from 0.1% to 2% by weight, optionally from 0.5% to 1.5% by weight. Some embodiments are free of Y₂O₃. High proportions of Y₂O₃ can adversely affect glass stability.

The glasses provided according to the invention may contain BaO. BaO can lower the melting temperature, which can prevent or reduce the reduction of the oxidation state of the glass constituents, especially of TiO₂ and Nb₂O₅. BaO can thus on the one hand stabilise high TiO₂ and Nb₂O₅ contents in the glass. On the other hand, however, a high BaO content can have an adverse effect on refractive index. The proportion of BaO is within a range from 0% to less than 10% by weight, optionally from more than 0% by weight to 9% by weight, optionally 1% to 9% by weight, optionally from 2% to 8.5% by weight. In some embodiments, the proportion of BaO is within a range from 1% to 6.5% by weight, optionally from 2% to 6% by weight. In some embodiments, the proportion of BaO is within a range from 5% to 9.5% by weight, optionally from 6% to 9% by weight. Some embodiments are free of BaO.

The glasses provided according to the invention may contain HfO₂, especially in order to increase the refractive index. The proportion of HfO₂ is optionally within a range from 0% to 1% by weight, for example 0.05% to 0.4% by weight or 0.1% to 0.25% by weight. Small proportions of HfO₂ are generally unproblematic. Nevertheless, some embodiments are free of HfO₂.

The glasses provided according to the invention may contain alkali metal oxides, especially Li₂O. However, the glass is optionally free of alkali metal oxides. The proportion of Li₂O is optionally within a range from 0 to 0.5% by weight, for example 0.05% to 0.2% by weight. Li₂O is known for its aggressiveness with respect to ceramic tank and crucible materials and can also lead to opacity of the glass and disadvantageous crystal formation, and is therefore used only in small amounts, if at all. The glass is optionally free of Li₂O.

The glasses provided according to the invention may contain ZnO. Optionally, the proportion of ZnO is less than or equal to 2.0% by weight, optionally less than or equal to 1.5% by weight, optionally less than or equal to 1% by weight or less than or equal to 0.5% by weight. ZnO lowers the refractive index of the glass and can adversely affect the physical properties of the glass. Therefore, the glass is optionally free of ZnO.

In some embodiments, the glass consists to an extent of at least 95.0% by weight, especially to an extent of at least 98.0% by weight or to an extent of at least 99.0% by weight, of the components SiO₂, B₂O₃, La₂O₃, Gd₂O₃, Nb₂O₅, TiO₂ and ZrO₂, or optionally of the components SiO₂, B₂O₃, La₂O₃, Gd₂O₃, Nb₂O₅, TiO₂, ZrO₂ and BaO. In some embodiments, the glass consists essentially completely of the components SiO₂, B₂O₃, La₂O₃, Gd₂O₃, Nb₂O₅, TiO₂, ZrO₂ and HfO₂, or of the components SiO₂, B₂O₃, La₂O₃, Gd₂O₃, Nb₂O₅, TiO₂, ZrO₂, HfO₂ and BaO.

The glass provided according to the invention is optionally free of one or more constituents selected from MgO, CaO and SrO. The glass is optionally free of MgO, CaO and SrO. These components lower the refractive index and destabilise the glass. The same applies to Al₂O₃. The glass is therefore optionally free of Al₂O₃.

The glass is optionally free of one or more of the constituents WO₃, Ta₂O₅ and/or GeO₂. The glass is optionally free of WO₃, Ta₂O₅ and GeO₂. When these constituents are present, there is considerable increase in batch costs. Moreover, Ta₂O₅ and WO₃ increase the density of the glass.

The melts of the glass can be refined with the customary refining agents. But since the glasses can be melted at temperatures below 1300° C. in particular and, because of their low toughness, refining is also possible at comparatively moderate temperatures, it is possible to lower the content of, for example, Sb₂O₃, As₂O₃ and/or SnO₂ in favour of UV transmittance (for example to <0.1% by weight), or to dispense with them entirely (purely physical refining). Sb₂O₃, As₂O₃ and SnO₂ can be used as refining agents. They are used only in small amounts. Arsenic and antimony in particular are controversial owing to health risks. The glass can be defined without chemical refining agents. Optionally, the glass may include one or more of the following components having refining action in the specified proportions in % by weight:

| | |
|---|---|
| Sb₂O₃ | 0.0 to 0.5 |
| As₂O₃ | 0.0 to 0.5 |
| SnO₂ | 0.0 to 0.5. |

Refining with SnO₂ requires comparatively high temperatures. Therefore, SnO₂ is optionally dispensed with. The glasses provided according to the invention are optionally free of SnO₂.

Sb₂O₃ has been found not to be very effective for the refining, and the absorption of Sb in the glass can worsen the UV edge. Therefore, Sb₂O₃ is optionally dispensed with. The glasses provided according to the invention are optionally free of Sb₂O₃.

As₂O₃ can be dispensed with owing to the health risks in particular. The glasses provided according to the invention are optionally free of As₂O₃.

In some embodiments provided according to the invention, sulfate can be used as refining agent. However, sulfate raw materials frequently include iron, which can be associated with a deterioration in transmittance. Therefore, sulfate raw materials are optionally dispensed with. The glasses provided according to the invention are optionally free of sulfate.

Moreover, neither As₂O₃ nor sulfate is helpful against N₂ bubbles. If N₂ bubbles should occur, they can be avoided, for example, by using a protective gas atmosphere, optionally CO₂ or argon, in order to keep N₂ away from the surface of the melt.

The glasses provided according to the invention are optionally free of absorbing components, especially free of components having absorption in the visible region. Optionally, the glasses provided according to the invention are free of Fe₂O₃.

The glass is optionally free of phosphate (P₂O₅), since it makes the melt much more reducing and hence distinctly increases the oxygen demand of the melt. The glass is optionally essentially free of one or more, optionally of all, constituents selected from lead, bismuth, cadmium, nickel, platinum, arsenic and antimony.

When it says in this description that the glass is free of a component or does not contain a certain component, what this means is that said component may be present as impurity at most in the glass. This means that it is not added in significant amounts. Non-significant amounts in accordance with the invention are amounts of less than 200 ppm, optionally less than 100 ppm, optionally less than 50 ppm and optionally less than 10 ppm (m/m).

The proportion of platinum is optionally very particularly low since platinum lowers the transmittance of the glass to an exceptional degree. The proportion of platinum is optionally less than 5 ppm, optionally less than 3 ppm, optionally less than 1 ppm, optionally less than 50 ppb, optionally less than 20 ppb.

In some embodiments, the invention relates to a glass article that includes or consists of the glass described. The glass article may have different forms. The glass article optionally has the form of a
spectacle lens, especially in the form of a stack of wafers,
wafer, especially having a maximum diameter of 5.0 cm to 40.0 cm,
lens, especially a spherical lens, prism or asphere, and/or
optical waveguide, especially a fiber or sheet.

In some embodiments, the invention relates to the use of a glass or glass article described herein in AR eyeglasses, wafer-level optics, optical wafer applications or conventional optics. Alternatively or additionally, the glass or glass article described herein may be used as wafer, lens, spherical lens or optical waveguide.

The present invention also relates to a method of producing a glass or glass article provided according to the invention. The method comprises the following steps:
melting the glass raw materials,
optionally forming a glass article from the glass melt,
cooling the glass.

The glass raw materials can be melted at relatively low melting temperatures because of the glass composition provided according to the invention. Comparatively low melting temperatures may be advantageous in order not to reduce the oxygen content of the batch to greatly, which can otherwise lead to browning by niobium or to relatively intense yellowing by reduced titanium. The glass raw materials are optionally melted at melting temperatures of less than 1400° C., optionally lower than 1350° C., optionally lower than 1330° C. The production method provided according to the invention may also include a refining step. The refining temperatures are optionally also comparatively low, especially less than 1550° C., optionally less than 1450° C., optionally less than 1400° C., optionally less than 1350° C. Preference may be given to purely physical refining, i.e. without the addition of refining agents.

The refining temperature optionally exceeds the melting temperature by not more than 100° C., optionally by not more than 50° C.

Preference may be given to dispensing with O₂ bubbling and passing of O₂ over the glass. Because of the optionally lower process temperatures, the melt retains sufficient O₂ even without addition of O₂ in order to maintain the highest oxidation states of, for example, Nb(V) or Ti(IV) that are required for the UV edge without Pt additionally getting into the glass.

The glass is optionally cooled at a cooling rate within a range from 1 K/h to 20 K/h, optionally 1.15 K/h to 15 K/h, optionally 1.3 K/h to 10 K/h. Low cooling rates may be advantageous in particular for reduction or avoidance of stresses.

### EXAMPLES

The example compositions shown in % by weight in the tables that follow were melted, and their properties were examined.

TABLE 1
“High-lanthanum variants”

| | 1 | 2 | 3 | 4 | 5 | 6 |
|---|---|---|---|---|---|---|
| SiO₂ | 9.0 | 9.1 | 9.0 | 8.5 | 9.0 | 9.1 |
| B₂O₃ | 5.0 | 8.5 | 5.8 | 5.6 | 5.0 | 4.9 |
| BaO | 2.5 | 5.1 | 4.5 | 4.0 | 6.1 | 5.8 |
| ZnO | 0 | 0 | 0 | 0 | 0 | 0 |
| La₂O₃ | 47.0 | 43.8 | 44.3 | 42.9 | 40.0 | 42.0 |
| Gd₂O₃ | 7.4 | 4.9 | 4.9 | 7.8 | 6.8 | 5.4 |
| Nb₂O₅ | 10.3 | 9.7 | 11.7 | 8.8 | 10.7 | 10.8 |
| Y₂O₃ | 1.0 | 1.0 | 1.5 | 1.0 | 1.5 | 1.5 |
| TiO₂ | 14.9 | 15.5 | 15.4 | 17.4 | 19.0 | 18.6 |
| ZrO₂ | 2.8 | 2.4 | 2.8 | 3.8 | 1.9 | 1.9 |
| Sb₂O₃ | 0 | 0 | 0 | 0 | 0 | 0 |
| HfO₂ | 0.1 | 0.1 | 0.1 | 0.1 | <0.1 | <0.1 |

Properties

| | | | | | | |
|---|---|---|---|---|---|---|
| Density | 5.07 | 4.78 | 4.96 | 5.00 | 4.92 | 4.91 |
| [g/cm³] | | | | | | |
| nd | 2.0065 | 1.9700 | 2.0035 | 2.0136 | 2.0187 | 2.0140 |
| vd | 27.9 | 28.2 | 27.4 | 26.9 | 25.9 | 26.2 |
| nF | 2.0321 | 1.9945 | 2.0296 | 2.0404 | 2.0468 | 2.0416 |
| nC | 1.9961 | 1.9601 | 1.9929 | 2.0028 | 2.0074 | 2.0028 |
| Tg[° C.] | 749 | 704 | 737 | 737 | 736 | 730 |
| Melting | 1300 | 1300 | 1300 | 1300 | 1300 | 1300 |
| temperature | | | | | | |
| [° C.] | | | | | | |
| Refining | 1330 | 1330 | 1300 | 1330 | 1330 | 1330 |
| temperature | | | | | | |
| [° C.] | | | | | | |
| TI(10 mm, | 0.88 | 0.84 | 0.89 | 0.85 | 0.82 | 0.84 |
| 420 nm) | | | | | | |
| TI(10 mm) | 0.95 | 0.91 | 0.95 | 0.93 | 0.90 | 0.92 |
| 460 nm | | | | | | |
| CTE(20.300) | 8.4 | 8.1 | 8.3 | 8.4 | 8.3 | 8.3 |
| [ppm/K] | | | | | | |
| Density/nd | 2.53 | 2.44 | 2.48 | 2.48 | 2.44 | 2.44 |

| | 7 | 8 | 9 | 10 | 11 | 12 |
|---|---|---|---|---|---|---|
| SiO₂ | 9.0 | 9.0 | 9.0 | 9.1 | 7.9 | 8.0 |
| B₂O₃ | 8.3 | 8.4 | 9.0 | 9.0 | 9.1 | 5.9 |
| BaO | 5.1 | 5.1 | 8.2 | 8.3 | 8.9 | 2.5 |
| ZnO | 0 | 0 | 0 | 0 | 0 | 0 |
| La₂O₃ | 44.0 | 43.8 | 31.4 | 31.9 | 30.5 | 47.2 |
| Gd₂O₃ | 4.0 | 3.9 | 7.7 | 7.4 | 7.8 | 7.4 |
| Nb₂O₅ | 9.7 | 9.7 | 7.4 | 7.4 | 8.7 | 10.3 |
| Y₂O₃ | 1.0 | 1.0 | 1.0 | 1.5 | 1.2 | 1.0 |
| TiO₂ | 17.5 | 19.0 | 23.4 | 23.0 | 23.0 | 14.8 |
| ZrO₂ | 1.4 | 0 | 2.8 | 2.4 | 3.0 | 2.8 |
| Sb₂O₃ | 0 | 0 | 0 | 0 | 0 | 0 |
| HfO₂ | <0.1 | <0.1 | 0.1 | 0.1 | <0.1 | 0.1 |

Properties

| | | | | | | |
|---|---|---|---|---|---|---|
| Density | 4.75 | 4.73 | 4.59 | 4.58 | 4.63 | 5.07 |
| [g/cm³] | | | | | | |
| nd | 1.9792 | 1.9849 | 1.9930 | 1.985 | 2.0035 | 2.0053 |
| vd | 27.3 | 26.6 | 24.9 | 25.2 | 24.6 | 28.0 |
| nF | 2.0048 | 2.0113 | 2.0215 | 2.0132 | 2.0326 | — |
| nC | 1.9689 | 1.9743 | 1.9816 | 1.9742 | 1.9918 | — |
| Tg[° C.] | 703 | 699 | 692 | 690 | 688 | 740 |
| Melting | 1300 | 1300 | | | 1300-1330 | 1300 |
| temperature | | | | | | |
| [° C.] | | | | | | |
| Refining | 1330 | 1330 | | | 1330 | 1330 |
| temperature | | | | | | |
| [° C.] | | | | | | |
| TI(10 mm, | 0.79 | 0.74 | | | | 0.89 |
| 420 nm) | | | | | | |
| TI(10 mm) | 0.87 | 0.85 | | | | 0.95 |
| 460 nm | | | | | | |
| CTE(20.300) | 8.1 | 8.1 | | | | 8.44 |
| [ppm/K] | | | | | | |
| Density/nd | 2.40 | 2.38 | 2.30 | 2.30 | 2.31 | 2.53 |

The glasses of the examples have low density coupled with high refractive index. Examples 1 to 8 also have high internal transmittances.

In the sole FIGURE, the ratio of the proportions by weight of TiO₂ and Nb₂O₅ is plotted against the sum total of the proportions by weight of La₂O₃ and Nb₂O₅ of the glasses provided according to the invention. The glasses provided according to the invention are shown as dots along the straight line drawn in, and have comparatively low density at high refractive index. The glasses having a higher weight ratio of TiO₂ to Nb₂O₅ and consequently a lower sum total of the proportions by weight of La₂O₃ and Nb₂O₅ are found here to have an even lower density than glasses with a low weight ratio of TiO₂ to Nb₂O₅. The straight line shown accordingly enables modification of the glasses provided according to the invention with regard to their contents of TiO₂, Nb₂O₅ and La₂O₃ such that the density desired for the particular application is obtained for the same refractive index. Moreover, it is simultaneously made possible to establish a defined TiO₂ to Nb₂O₅ ratio for the particular refractive index. This can affect the transmittance properties of the glass since, with rising TiO₂ and Nb₂O₅ content, there is a rise in the oxygen demand of the melt, the glasses become more redox-sensitive and hence transmittance can be worsened. In summary, it is thus possible to adjust the density and transmittance of a glass provided according to the invention for a refractive index within the target range so as to obtain a glass optimized for the respective application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass having a refractive index at a wavelength of about 587.6 nm of 1.95 to 2.05 and a dispersion of 22 to less than 35, comprising the following components in % by weight:

| | |
|---|---|
| SiO₂ | 4-12; |
| B₂O₃ | 4-11; |
| BaO | <10; |
| La₂O₃ | 30-<52; |
| Gd₂O₃ | <14; |
| ZrO₂ | <5.5; |
| TiO₂ | 10-25; |
| Nb₂O₅ | 3-16; and |
| ZnO | ≤2.0, |

wherein a sum total of the proportions by weight of SiO₂ and B₂O₃ is at least 10% by weight. the sum total of the proportions by weight of SiO₂ and B₂O₃ is at least 10% by weight weight.

2. The glass of claim 1, wherein a proportion of Y₂O₃ in the glass is from 0% to 5% by

3. The glass of claim 2, wherein the proportion of Y₂O₃ in the glass is from 0.1% to 2% by weight.

4. The glass of claim 3, wherein the proportion of Y₂O₃ in the glass is from 0.5% to 1.5% by weight.

5. The glass of claim 1, wherein the proportion of a sum total of La₂O₃, TiO₂ and BaO is 55% to 70% by weight.

6. The glass of claim 1, wherein the proportion of BaO is from more than 0% to 9% by weight.

7. The glass of claim 6, wherein the proportion of BaO is from 1% to 9% by weight.

8. The glass of claim 7, wherein the proportion of BaO is from 2% to 8.5% by weight.

9. The glass of claim 1, wherein the proportion of ZrO₂ is from 0.5% to 5% by weight.

10. The glass of claim 9, wherein the proportion of ZrO₂ is from 0.5% to 4.5% by weight.

11. The glass of claim 10, wherein the proportion of ZrO₂ is from 1.0% to 4.0% by weight.

12. The glass of claim 1, wherein the proportion of ZnO is ≤1.5% by weight.

13. The glass of claim 12, wherein the proportion of ZnO is ≤1.0% by weight.

14. The glass of claim 13, wherein the proportion of ZnO is ≤0.5% by weight.

15. The glass of claim 1, wherein a weight ratio of the proportion of SiO₂ to the proportion of B₂O₃ (SiO₂/B₂O₃) is within a range from 0.85 to 2.0.

16. The glass of claim 15, wherein the weight ratio of SiO₂/B₂O₃ is from 0.95 to 1.9.

17. The glass of claim 1, wherein the glass has an internal transmittance of at least 80%, measured at a wavelength of 460 nm and a sample thickness of 10 mm.

18. The glass of claim 1, wherein a weight ratio of a sum total of the proportions of Nb₂O₅ and ZrO₂ to the proportion of TiO₂ is less than 1.

19. The glass of claim 18, wherein the weight ratio of the sum total of the proportions of Nb₂O₅ and ZrO₂ to the proportion of TiO₂ is less than 0.9.

20. A glass article, comprising:
a glass having a refractive index at a wavelength of about 587.6 nm of 1.95 to 2.05 and a dispersion of 22 to less than 35, comprising the following components in % by weight:

| | |
|---|---|
| SiO₂ | 4-12; |
| B₂O₃ | 4-11; |
| BaO | <10; |
| La₂O₃ | 30-<52; |
| Gd₂O₃ | <14; |
| ZrO₂ | <5.5; |
| TiO₂ | 10-25; |
| Nb₂O₅ | 3-16; and |
| ZnO | ≤2.0, |

wherein a sum total of the proportions by weight of SiO₂ and B₂O₃ is at least 10% by weight;
the glass article being in the form of:
a spectacle lens;
a stack of wafers;
a wafer;
a lens;
a spherical lens;
a prism;
an asphere;
an optical waveguide;
a fiber; or
a sheet.
